(19) United States
(12) Patent Application Publication
(10) Pub. No.: US 2018/0158004 A1
(43) Pub. Date: Jun. 7, 2018

(54) Requesting Information from Organizations

(71) Applicants: Ali DAVAR, Vancouver (CA); Kurt Robert KOLB, Burnaby (CA); David Robert THOMPSON, Vancouver (CA); Simon James HEWITT, Vancouver (CA); Maziyar HAMDI, Vancouver (CA)

(72) Inventors: Ali DAVAR, Vancouver (CA); Kurt Robert KOLB, Burnaby (CA); David Robert THOMPSON, Vancouver (CA); Simon James HEWITT, Vancouver (CA); Maziyar HAMDI, Vancouver (CA)

(73) Assignee: 0934781 B.C. Ltd, Vancouver (CA)

(21) Appl. No.: 15/367,487

(22) Filed: Dec. 2, 2016

(51) Int. Cl. G06Q 10/06

(52) U.S. Cl. CPC G06Q 10/0637

(57) ABSTRACT

A computer method and system automates requesting and processing business information from vendors for potential clients, preferably in a two-sided market for business services. The system comprises a database of business relationships between organizations, which may be used to automate the request process. A user may search for vendors according to a search query and select a set of vendors. The system may identify and calculate the relevance of data to be in questions and responses communicated between the client and the vendors.

### BACKGROUND

In the area of Business-to-Business (B2B) relationship building and procurement, it is common for businesses as a potential client to begin by searching for a set of vendors that appear to match the client's requirements. Assuming that there is a considerable amount of money at stake and that management buy-in is required for approval, buyers will go through a series of processes to gather information and evaluate the vendors.

The client may request business information from vendors. One common process is the Request for Information (RFI), which can be an informal step to gather pertinent information and may be followed by a Request for Quotation (RFQ) or a Request for Proposal (RFP) process. An RFQ is commonly used to solicit a number of prices and terms for a definable product or service or commodity. An RFP is commonly used to solicit solutions to a defined problem. This is typically a formal process in terms of timelines, solutions, and prices.

These processes have traditionally been done manually by the buyer's team generating a series of relevant questions and defining as much of their needs as possible and sending the Request to the vendors. The vendors individually provide information, answers and their best efforts to secure the business.

Numerous attempts have been made to automate this process. U.S. Pat. No. 6,356,909 teaches a system comprising a set of predefined questions from the potential client and stored responses from a vendor. The client and vendor can select and edit the predefined questions and responses. In general, these software systems, often called eRFP systems, attempt to automate and simplify the RFP process using past and new information provided by the users.

### BRIEF SUMMARY OF THE INVENTION

The inventors have appreciated that the process can be improved by using a database of information about the vendors, their clients, the buyers and relationships therebetween. This may provide a richer source of information for generating the Request than a user could provide themselves. The inventors have envisaged a database, network, system, and methods for operating with business data for evaluating vendors. The inventors have appreciated that the database may comprise data about organizations that would be unknown to both the vendor and clients.

According to one innovative aspect, certain exemplary embodiments provide a computer-implemented method of requesting information about a plurality of vendors or their products. The method comprises a server recommending a set of questions to a first user associated with a potential client; the server communicating the request questions to a plurality of second users associated with the plurality of vendors; the server recommending a personalized set of responses to said request questions to the second users; the server providing a user-interface to enable the second users to approve or edit the recommended set of responses to form final responses; and the server communicating said final responses to the first user. The recommended set of questions are selected based on attributes of the potential client and recommended set of responses are selected based on attributes of the respective vendor, all of said attributes being stored on a database accessed by the server.

According to another innovative aspect, certain exemplary embodiments provide a computer-implemented method comprising: a server receiving a request to contact a plurality of vendors from a first user associated with a potential client, the vendors selected via a website accessing a database of organizations; a server retrieving, from the database, data about each of the plurality of vendors or about their relationships with their clients; the server determining data types that are relevant to the potential client in relation to selecting vendors; and for each vendor, the server, determining a set of differences in the data between that vendor and the other vendors which are relevant to the potential client and communicating the set of differences to a second user associated with that vendor.

According to another innovative aspect, certain exemplary embodiments provide a computer-implemented method of evaluating an information request about a plurality of vendors. The method comprises: a server receiving, from a first user associated with a potential client, a request to communicate project requirements to a plurality of vendors, the vendors selected via a website accessing a database of organizations; the server estimating the financial worth of the project using data about the potential client retrieved from a database of organizations; and the server communicating, to second users associated with the plurality of vendors, the project requirements and the estimated financial worth of the project.

According to another innovative aspect, certain exemplary embodiments provide a computer-implemented method of managing access to a request for information. The method comprises: receiving, from a first user associated with a potential client, a request for information from a plurality of vendors; determining access rights for each of the vendors from a memory; providing a user-interface to a vendor-users associated with the vendors, the user-interface having software features for viewing and responding to the request; and enabling or disabling certain features for each vendor-user based on the access rights of the respective vendor.

The access rights of each vendor may determine whether the server retrieves attributes of the potential client from the database and displays them via the user-interface.

The request may include a plurality of questions and wherein the access rights of each vendor determines whether the server communicates all or only some of the questions to the respective vendor-user.

The access rights of each vendor may determine whether the request is sent to respective vendor-users at a first time or a second time, later than the first time, preferably at least a day later.

The access rights of each vendor may determine whether a response prepared by that vendor comprises one or more of: aggregated attributes of that vendor's existing clients, infographics, or stored sales material.

According to another innovative aspect, certain exemplary embodiments provide a computer-implemented method comprising: in response to a first user associated with a potential client initiating a request action, a server preparing a request for information about a plurality of vendors; the server identifying, from a social network, social connections between employees of the potential client and employees of the vendors or their existing clients; for each vendor, the server sending, to second users associated with that vendor, the prepared request and identity data of the employees identified with respect to that vendor.

According to another innovative aspect, certain exemplary embodiments provide a computer-implemented method of scoring vendors for the benefit of a potential client, the method comprising: receiving responses from a plurality of vendors to a set of questions; retrieving, from a database of relationships between organizations, attribute data of clients of the vendors and of organizations similar to the potential client, creating a model of scoring preferences based on said data; estimating scores for the responses for each vendor using the model; and communicating the responses and the scores to a first user associated with the potential client.

The model may comprise question weights for the questions, the question weights increasing with an increase a) in the differentiation of responses to a given question and b) relevance of questions to the potential client's industry.

The model may use past scores of clients to similar responses to similar questions to the immediate questions in order to estimate the scores for the potential client.

The server may receive first-user-scores via a UI and checking for consistency of said scores across responses to the same question.

The responses may be provided to the first user without communicating identity data of the corresponding vendors.

The server may share responses with a plurality of first-users associated with the potential client to score the vendors' responses collaboratively.

The server may tag questions to indicate which attribute type of the client or peer is relevant for scoring a questions

The server may verify vendor responses using data in the database about the vendor, their existing clients or relationships with existing clients.

The server may communicate responses to an existing client of the relevant vendor to verify those responses.

This summary does not necessarily describe the entire scope of all aspects. Other aspects, features and advantages will be apparent to those of ordinary skill in the art upon review of the following drawings and description of specific embodiments.

### BRIEF DESCRIPTION OF THE DRAWINGS

FIG. 1 is a diagram of agents for interaction between a client device and server.

FIG. 2 is a diagram of a database structure for relationships and organizations.

FIG. 3 is a flowchart for generating a request.

FIG. 4 is a table of questions for generating a request.

FIG. 5 illustrates the use of template questions and database to suggest questions to a user.

FIG. 6 is a flowchart for evaluating a request to a vendor.

FIG. 7 is a user-interface for viewing and responding to requests.

FIG. 8 is a web interface for responding using a database.

FIG. 9 is a user-interface for scoring vendor responses.

FIG. 10 is an illustration of a database of requests for use in formulating a response.

FIG. 11 illustrates an auction mechanism.

FIG. 12 is a flowchart for an auction.

### DETAILED DESCRIPTION

The present system automates and improves a process for requesting information about vendors or their services/products. In the present invention requesting information (aka the Request) is not limited by the purpose or nature of a particular known format such as an RFI, RFQ, or RFP. The Request may include aspects of an RFI, RFQ, RFP, or questionnaire. The Request may include questions, client background, reason for making the Request, or a detailed explanation of the services or products to be provided by a successful vendor. The Request is directed to a plurality of vendors, typically for the purpose of evaluating their services products and comparing them across vendors.

Previous attempts to automate vendor request processes have focused on providing a tool to help either the client or the vendor. Thus for the client, one system may store template questions relevant to the client and the client-user may enter data about themselves to be stored and reused during subsequent requests. This simplifies the client's efforts. Conversely a different system for the vendor may store template responses or data to be reused with common questions. This simplifies the process for the vendor. The present inventors have appreciated that a database comprising data about vendors, clients and relationships can not only simplify the process for both vendors and clients but also improve the questions and responses.

Thus rather than cater to one party or another, the system provides a neutral resource of unbiased data. Moreover, the database includes data that neither party could easily know. For example a client-focused system would not know whether a vendor serves similar clients and a vendor-focused system would not know how the client deals with their existing vendors. The technical challenge in automating such a process is the computer system being able to identify which aspects of a request are/most relevant to the information exchange, what data should be used from the database, and how to evaluate information from one party on behalf of the other party.

A system, network, and computer program are implemented to capture attributes of and relationships between organizations. In response to a user-initiated request for business information, the program employs various software agents to create request documents to communicate to a plurality of vendors and then receive response from vendors and optionally score them. The system and method may be said to be implemented using one or more processors, one or more servers, or one or more databases such that functions or data are not required exist on different or the same server, processor or database.

A computer system has one or more processors for reading instructions from computer-readable storage media and executing the instructions to provide the software agent and perform methods described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

An organization is generally used herein to refer to a legal entity providing or receiving products or services. While an organization may typically be a business, the term includes but is not limited to charities, corporations, sole proprietors, Non-Government Organizations (NGO), institutions, government departments, and partnerships. The term supplier is used herein to refer to organizations that supply products or services in a business relationship, notwithstanding that they may also consume products or services in another relationship. A business relationship is used herein to refer to a business-to-business (B2B) relationship or commercial transactions between organizations to provide those products or services. Preferably the relationship represents an agreement, which, for example, may subsist in a contract, a terms-of-business document or an ongoing understanding. Most preferably the business relationships stored in the database represent relationships that have been ongoing for at least three months or have at least three repeat instances of transactions. This is in contrast to personal relationships, non-commercial relationships, click-thru data or user website activity data, or one-off commercial transactions. Therefore the strength of the present recommendation is derived from a deep tie between organizations, as recorded in the database. An ongoing, high-value relationship is used as a proxy to suggest that the products or services are of high-importance to an organization.

The organizations may be termed clients (aka consumers, buyers) or vendors (aka suppliers) to indicate their status with respect to a B2B relationship for supply of products for services. Rather than store the client/vendor status with the organization data object, it is preferable to store the status with the relationship or product/service data object because an organization may be a vendor in one relationship and a client in another.

A user is generally used herein as a person who interacts with a computer, typically entering search criteria, initiating a request process, entering data, and selecting questions or answers for the response. The user is expected to be associated with a particular organization either seeking information as a potential client or providing information as a vendor. Herein the term ‘client-user’ is used to refer to user acting on behalf of a potential client and ‘vendor-user’ is used to refer to a user acting on behalf of a vendor. There may be many client-users and vendor-users involved in a single request for information.

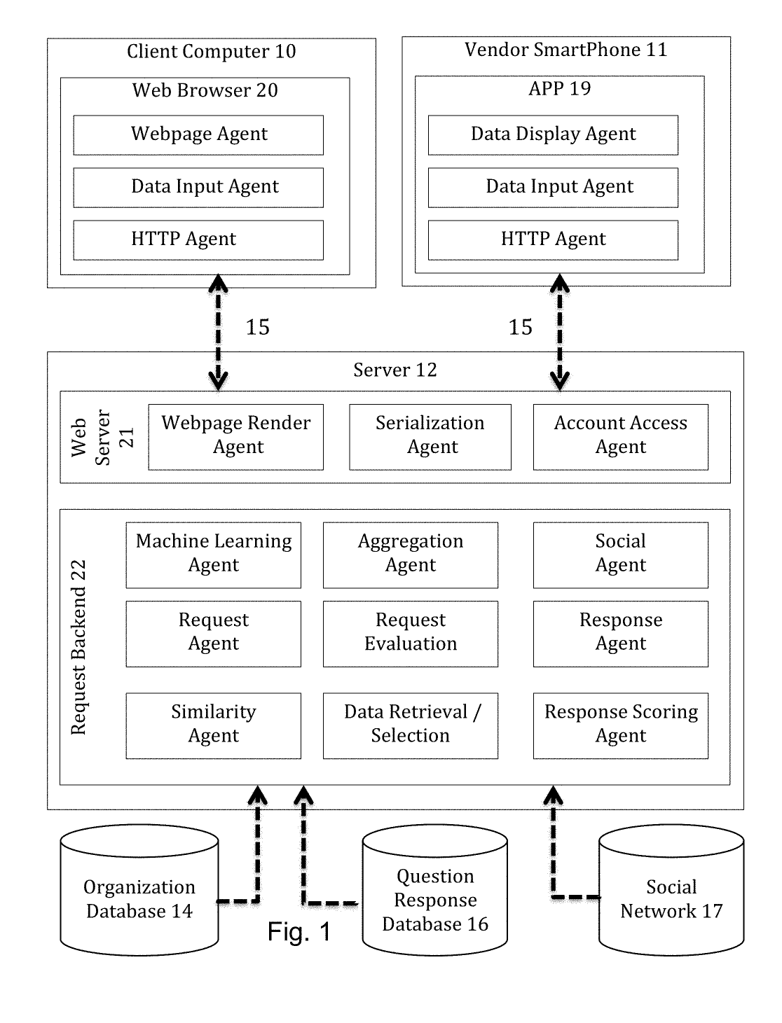

FIG. 1 illustrates the interaction between a client computation device 10 or a vendor Smart Phone 11 and a server 12 over network link 15. The devices 10, 11 may communicate via a web browser 20 or smart APP 19, using software agents to receive input from the user, make HTTP requests and display data. The server 12 may be a reverse proxy server for an internal network, such that the client device 10 communicates with an Nginx web server 21, which relays the client's request to backend processes 22, associated server(s) and database(s) 14, 16, 17. Within the server software agents retrieve organization data, question/response templates, and social data from the databases 14, 16, 17. Some software agents may operate within a notional web server to manage user accounts and access, serialize data for output, render webpages, and handle HTTP requests from the devices 10, 11. Some software agents may operate as backend processes to calculate scores, make recommendations to users and automate the request process.

Users may access the databases remotely using a desktop or laptop computer, smartphone, tablet, or other client computing device 10 connectable to the server 12 by mobile internet, fixed wireless internet, WiFi, wide area network, broadband, telephone connection, cable modem, fibre optic network or other known and future communication technology.

The devices 10, 11 may interact with the server 12 using a web browser using conventional Internet protocols. The web server will use the serialization agent to convert the raw data into a format requested by the browser. Some or all of the methods for operating the database may reside on the server device. The devices 10,11 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device. The devices and server may communicate via HTTP requests.

The methods and database discussed herein may be provided on a variety of computer system and are not inherently related to a particular computer apparatus, particular programming language, or particular database structure. The system is capable of storing data remotely from a user, processing data and providing access to a user across a network. The server may be implemented on a stand-alone computer, mainframe, distributed network or over a cloud.

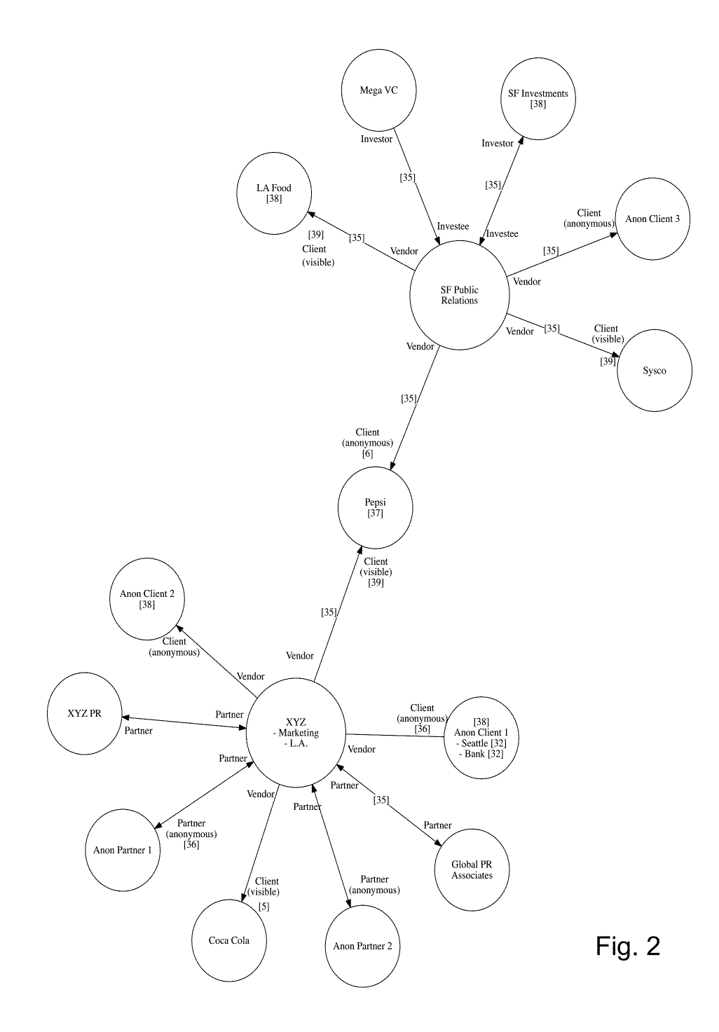

As conceptualized in FIG. 2, the database is structured to record a plurality of relationships 35 with data about the relationships such as the nature of the relationship, attributes 32 about the organizations 38, and identification data (such as a name). A code may be used in the database to indicate that a party is a visible party 39 or an anonymous party 36.

There may be only one relationship recorded for an organization but in most cases there will be many. The database may include millions of organizations and relationships.

A relationship data object may include relationship attribute data giving further details such as the good and services, time frames involved, investment amount, product type, sales amount, or terms of the contract. The relationship data object may also include data about a case study or completed project, which might be added to a vendor's proposal as evidence of ability.

### Database Format

The database may be implemented in a variety of ways known within computing science, such as an object database, relational database or a graph database. As used herein a collection of data about an organization is called a data object, without limitation to a specific data schema.

In certain embodiments, a graph database is used, wherein organizations are stored as nodes and business relationships are stored as edges. This is illustrated in FIG. 2 by solid lines between organization circles with arrows to indicate the direction of the flow of goods or services from a vendor to a client.

The graph may include a second type of edge (similarity edge), which records the degree to which one is similar to another. The similarity edge may be non-directional or bidirectional to indicate that two organizations are mutual peers or the peer edge may be unidirectional to indicate that one organization is considered a peer of another organization but not vice versa, or at least not in the same way or degree.

### Data Source

The system's data input agent provide one or more ways to input a business relationship to the database, such as a website form, receiving a data file, an API callable by third-party software, and a web crawler. Preferably the relationship is input by a user working on behalf of one of the organizations and includes details about the relationship and the other organization. In one embodiment, a web crawler scours the webpages of organizations and/or news websites to find relationships between organizations.

In one embodiment, a user inputs the relationship data. The user registers and account with the present system on behalf of their organization. The user's email domain, LinkedIn™ account, or Customer Relationship Management software can be used to upload data about the organizations and the relationship.

Preferably the user inputs the relationship details into a user-interface provided by the web server. The interface provides for an option to mark the other organization as ‘anonymous’, i.e. to be hidden from other users. Equivalently the user selects the other organization's ‘visibility’ towards other users. This status is stored as a flag in the relationship record.

The system stores data for organizations in the database and can find or compare organizations depending on the nature of the data. The organization data may be conceptually divided into different categories:

Identification data that enable the system to identify the organization. Identification data includes data such as legal name, parent company name, CEO's name, office address, IP address, logos, brand names, or company registration number;

Profile information about the organization history, expertise, and accomplishments, possibly in an unstructured text format;

Attribute data that describe properties of the organization using categories or values, but do not identify the organization. Attribute types may include industry, sector, general location, specialization, product category, service category, number of employees, market capitalization, field of practice, or revenue; and

Business segment data, as a subset of attribute data, for describing the business function or division of an organization that includes attribute types such as industry, sector, specialization, product class, service class, or field of practice.

### Similarity

It is possible that some peers to one organization are not peers to all other members of that peer group or they may have additional peers not in that peer group. An organization that provides two distinct services will have two sets of peers, whereby members of each set may not consider the other set to be in their own peer group. Alternatively a similarity metric may be calculated between every organization in the database. This is computationally expensive and so this calculation is preferably processed offline and stored in the database. Preferably a similarity agent only records similarity edges that are greater than a threshold similarity, so as to reduce the need to store data for minimally similar organizations.

In some cases, an organization will not have been recorded in the database with similarity edges to any known peers. In this case, similar or peer organizations are determined in real-time. Rather than calculate similarity values for all organizations with the potential client, it is computationally more efficient to determine a set of existing clients that receive goods or services from the selected vendors and then calculate a similarity or peer score between each existing client and the potential client.

A similarity edge may have a value measuring the degree of similarity or relevance. Alternatively, similarity edges may be recorded as either TRUE or FALSE.

As used herein, the terms ‘similar’ and ‘peers’ are related. Organizations may be considered similar because they have many attributes in common. Peers are similar with the added provision that they are in the same or related business segment (e.g. industry/sector/specialism and/or offer related products or services). Thus two organizations that have similar attribute data for size, location, and age may be considered similar but may not be considered peers if they are defined by non-similar business segment data. Organizations in the same business segment may be considered peers, and comparing other attribute data, such as revenue, location, and specialism, can further refine the peer score. The skilled person will appreciate there are many known algorithms to calculate similarity metrics and/or perform peer clustering using attributes. For example, similarity metrics could be based on Jaccard similarity coefficients or cosine distance, and peers could be clustered using expectation maximization, hierarchical clustering or density-based clustering algorithms.

Calculation and usage of a similarity metric is described in more detail in U.S. Ser. No. 14/537,092, incorporated herein in its entirety.

### Classification

The database attribute data structure may have a number of standard attribute types and, for each type, a limited number of standard values. Example types include city or number of employees having example values Boston/London/Madrid and 5-10/100-500, respectively. A classifier agent includes algorithms to classify new data about an organization into the appropriate attribute type. For example the classifier may be a Decision Tree, Random Decision Forests, or Naïve Bayesian Classifiers available from machine learning tools such as SciKit Learn or Weka. For each standard term, there is a vocabulary of synonyms. The classifier parses through an organization's profile data or scrapes the organization's webpage or other records for phrases and terms that are likely to be descriptive of the organization. These phrases and terms are compared to the vocabularies to determine the most suitable attribute value. The equivalent standard attribute values are stored in the database for that organization. Tools such as WordNet or algorithms based on co-occurrence statistics enable an algorithm to automate such synonym discovery to classify terms.

The system may employ a search engine, which uses the vocabulary lists to hash a user's free-text search string to the equivalent standard term for an attribute value. For example, a search for ‘a patisserie in the Bay’ would lead to ‘patisserie’ being matched to the standard term ‘baker’, whilst the term ‘Bay’ is matched to more than one location. The method would return all organizations having the attribute ‘Baker’ with locations associated with San Francisco Bay, Bay of Fundy, Bay of Biscay, etc.

Many classes and ranges may have one or more parent values or ranges, such as the NAICS system used to classify industry. For example, a winery could be classed in the Food and Beverage sector, the Beverage subsector, Alcoholic Beverages group, or the Wine Manufacturing subgroup. Moreover many companies may have attribute data in more than one class, such as the largest blue chip companies that serve many sectors, have products in different classes, and have subsidiary companies with very different employee counts. The database may be arranged to store sufficient attribute data to describe the organizations and the system includes software agents to classify and compare organizations across a plurality of attributes and levels.

### Select Vendors

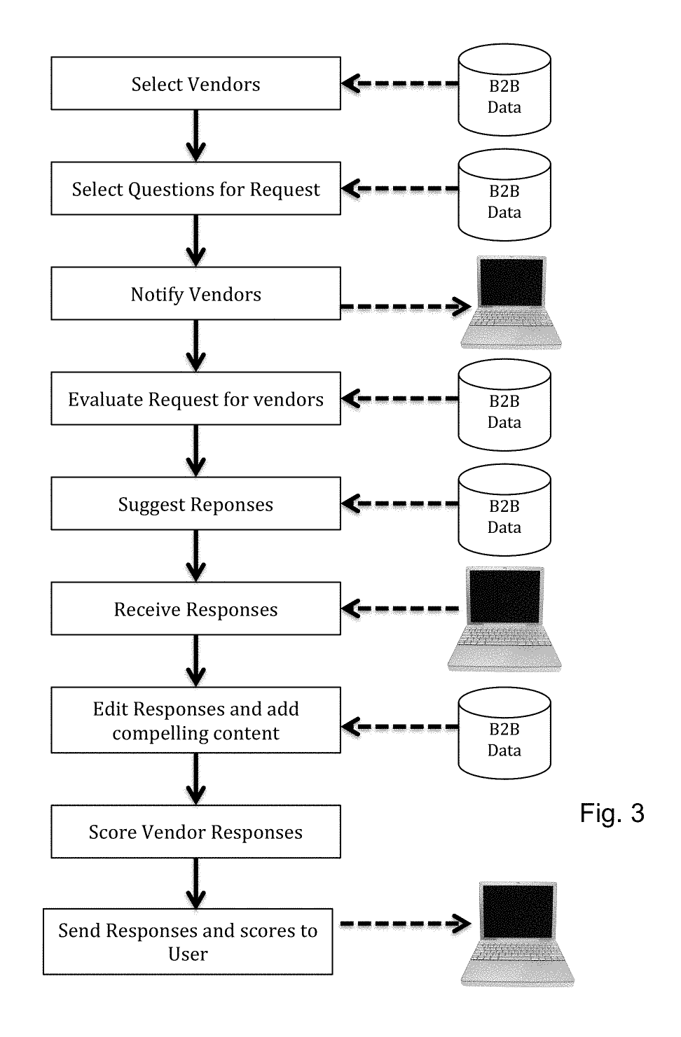

An advantage of certain embodiments of the present system is that the database already contains information about relevant vendors. It can thus suggest vendors to a client-user or at least already has data about vendors that the client-user inputs. An outline of a process for automating a Request to vendors is shown in FIG. 3, although various modifications are detailed in the sections below. A client-user selects vendors and initiates the request. With the help of the Request Creation agent, the user selects and edits questions to form the Request. The system notifies the vendors using electronic communication, such as email, text messaging, or queuing the Request in the vendors' accounts. An initial evaluation of the Request to the vendors is made, which may be communicated to the user or vendors. The vendor-user logs-on to the present system via the website or an app where their identity or association with the vendor is verified. The Response Agent suggests responses for each question, which are selectable and editable by the vendor-user. The Response Agent may add content to a vendor's response to improve the proposal. Responses are scored by a Scoring Agent and communicated to the user.

Compared to other automated RFP systems, the present system uses data about the organizations and their relations for almost every stage of the process. This simplifies and improves the quality of the process.

The user interacts with the user-interface (UI) to initiate a request for information, preferably by clicking on a Call-to-Action button. The vendors may be selected in several ways or combination thereof: the user manually entering vendor names; the user choosing from a list of displayed vendors that match a search query; a recommendation engine selecting vendors that are a best fit; the vendors self-selecting by responding to requests posted by users.

In one embodiment, the user selects a plurality of vendors from a list provided by the system, either as a directory of relevant vendors or a set of ranked vendors, ranked using an algorithm as discussed below. The client-user determines which of the vendors appear to be attractive to the potential client and requests that the system send those vendors the Request.

In another embodiment, the system selects the vendors for the user by determining which vendors best match a user's query or are likely to be a good fit for the potential client. For example, the system may select the top five vendors ranked by the recommendation engine. Alternatively the system may determine which vendors have previously been successful when responding to requests, particularly for organizations similar to the potential client. Thus the database may store request data objects connected to a client and a vendor, storing the score given to the response and optionally the questions and responses used.

In yet another embodiment, the Request is posted to an electronic marketplace or is communicated to a plurality of vendor. If a user associate with a vendor is interested in the Request, they may elect to respond. The system may then send all responses, or the top responses, to the user associated with the potential client.

### Recommendation Engine

A search query to find vendors from the database may take the form of a search string or clicking on a hyperlink or filter button for an attribute or name. The present recommendation engine accepts such requests at the webserver and returns a set of matching and recommended vendors.

Using keywords or selecting hyperlinks, the client-user indicates one or more criteria for the search of vendors. Preferably the criteria are directed to business segment data. Examples of business segment data for a law firm include: law firm′; lawyers′; ‘specializing in contact negotiation’; and ‘legal services’. Whereas size, revenue, and location are examples of attribute data that would not indicate the type of an organization, but they could be used as criteria to refine the search, either as an input with the business segment criteria or selected during a subsequent step. The engine retrieves a set of data collections of vendors from the database that best satisfy the criteria.

The set of vendors may be output as an unordered set of all vendors suited for the potential client. To provide a more personalized view to the user, the engine preferable processes the vendor set according to a metric, such that a subset of vendors is output corresponding to the most relevant or highest scoring vendors.

The engine may calculate the recommendation metric for each vendor based on the sum of similarity values between the user and each client of that vendor. The engine may compare attribute data of these organizations as discusses elsewhere. A recommendation engine is discussed in patent application U.S. Ser. No. 14/537,092 filed 10 Nov. 2014, incorporating herein in its entirety.

### Creating Requests

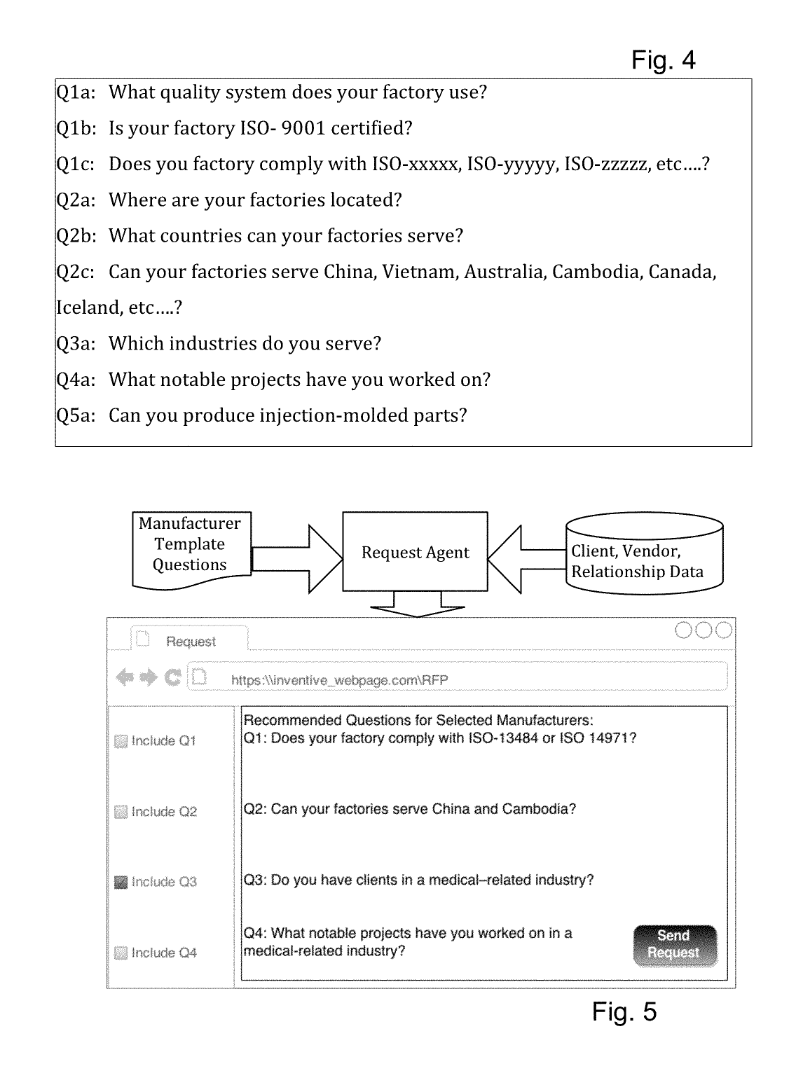

In order to simplify and automate the Request process, a Request Agent determines a set of questions relevant for evaluating a vendor or their product/service. Preferably, the Request Agent determines the relevance of a set of questions with respect to the services or products supplied by the vendors and/or the search query. Some questions are selected from a database of questions based on the search query or the vendors' industry or category of their service/product. The questions may be open-ended, such as points for discussion and qualifying comments, or closed-ended, such as multiple-choice, pricing, or fact-based questions. Examples of template questions are shown in FIG. 4 for a vendor that is in the manufacturing industry.

Template questions suggested for all clients to cover an entire industry are too generic to be useful, likely being neither personalized to the needs of the potential client nor relevant to the vendors selected. For example, a small company is more likely to need to know the minimum rather than maximum production volumes of a factory and thus the agent will select appropriate questions or amend the template questions to capture this personal need. Potentially none of the selected vendors offer a particular specialty within their industry and thus questions related to that specialty are not selected. Thus the request creation agent personalizes the questions using organization and relationship data from the database. The request agent uses this data to select questions from the complete set of template questions based on the vendor's industry and personalizes the selected questions using data other than the vendors' industry or category of product/service. In exemplary embodiments, the questions database has at least 100 questions per industry, of which at most half are suggested to the user for a given Request.

The Request Agent retrieves data objects for the vendors, the potential client, and optionally the vendors' existing clients. This data might not have been known or considered by the users without the systems help. This data is used to suggest questions for the Request.

Efficiency in the request creation can be made by determining the range of responses likely using data of the selected vendors in order to construct the questions. Using attribute values and past responses of the selected vendors, the agent can determine likely responses in order to eliminate nonsensical questions, questions with only one likely response, or frame the question within the limits of the response range. For example, in a particular industry, it might be common to ask which quality systems are used. If the request creation agent determines that none of the selected vendors have a quality system or they all use the same one, then it can omit this question from the Request or return the known response immediately to the user. If the range of quality systems used by the selected vendors is just three systems, then the question can be limited to enquiring about these three, perhaps with more focus in the question than would be the case where the question was intended to be ant to a hundred quality systems.

In a similar sense, the perspective of the potential client is considered by determining the likely range of responses that would be of interest to them. Using the above example, the Agent could determine that a vendor needs to be compatible with either of two quality systems and thus otherwise valid questions pertaining to the overall industry are dropped or amended to focus on these two options.

The advantage of this efficiency is to remove questions that do not differentiate the vendors or require vendors and client to consider a wide range of responses where only a few are relevant to the parties. In a variant of this approach, the Request Agent may determine the value of a potential question to include in the Request. The value may depend on the degree to which a question will differentiate the vendors. Preferably this value is determined with respect to other questions such that only questions with a value greater than a threshold (absolute or relative) value are suggested to the client-user for inclusion.

The present system may maintain a hierarchy of questions, having general to specific questions. The Request Agent determines the range of responses of interest to the user or likely from the vendors and then selects a general question to cover a broad range of responses or a specific question to focus on a narrow range. The Agent selects the most specific question that is relevant to the range of likely responses.

The value of a potential question may be calculated from at least one of: the weight of the question; past response scoring by the user; or likely responses from the vendors based on their past responses or attribute values. Here again the process is improved by using the database to inform the questions. Thus a question is of high value to the extent that the question has a high weight (or was highly scored in a previous Request) and the responses from the vendors are likely or known to score very differently.

The Request Agent may call a Response Agent to retrieve data objects for the vendors and their relationships with clients to identify data that would answer a potential question. For example, questions about the vendors' size, locations, capabilities, clients served, etc. are knowable facts by the system and can be used to predict a vendor's response. Similarly data objects recording past responses to similar questions may be retrieved to predict responses that the vendor would use.

The Request Agent may call a Scoring Agent to estimate a score for each vendor using their predicted responses. The difference in the estimated scores across vendors is used to determine the value of a potential question, whereby highly differing estimated scores lead to highly valued questions. The value may be derived from the standard deviation or range of estimated vendor scores for the potential questions.

The Request Agent may also use the estimated scores to identify which set of potential questions separate the vendors, particularly as regards to the search query. This can be seen as determining question dimensions (preferably orthogonal dimensions) along which vendors can be plotted and separated. For example, the system may identify 100 potential questions; of which 50 are highly weighted and thus likely to contribute greatly to a vendor's total score. Of those 50, sixteen questions are estimated to produce different responses. Of the sixteen, ten questions would yield scores separating one half of the vendors from the other half but the other six questions would separate each vendor from the others. These last six questions are selected by the Request Agent as the best questions to recommend to the client-user to evaluate vendors.

An alternative or additional way of estimating the value of a question is to analyze the previous effect of a question in evaluating vendors that are the same or similar type to the presently evaluated vendors. The Request Agent may determine the industry or category or products/services of the vendors and retrieve data objects for previous Requests directed to the same or similar industry or category or products/services. The Request Agent identifies the score given to a question and determines the relative contribution to the total vendor scoring, particularly the degree to which a question scored vendors differently from each other.

The skilled person will appreciate that, in addition to the highly scored questions, the Request Agent may suggest other questions, preferably displaying a score or reason indicating that one set of questions is preferable to the others. There may be other reasons, such as due diligence, minimum industry requirements, and user preference for including the less highly scored questions in the Request.

In one embodiment, the Request Agent may select or amend questions depending on vendor filter values selected by the user. For example, if the user has selected a particular geographic area for the location filter, then geographic questions can be limited to that area, instead of enquiring about global capabilities of each vendor.

FIG. 5 shows a set of questions that have been selected or amended from the templates in FIG. 5 based on the data in the database and are being suggested to the user. In this example: Q1a is dropped as too open-ended with the possibility of making responses hard to compare or score; Q1b is relevant to the vendor's industry but dropped as irrelevant to the client's industry; and Q1c can be used but amended to the only response options that are relevant to the client's quality system, which are stored as attribute values. Likewise questions Q2a and Q2b are relevant but the system knows the factory locations of the vendor, specific countries already served according to their relationship data, and locations of the user's company. Thus Q2C is selected by the Request Agent but amended to the locations relevant to the client and served by the vendor. Q3 and Q4 have been amended to consider the client's industry (medical devices) but broadened, as the system knows that none of the selected vendors have clients within the narrower industry definition, but that there are some within the broader industry definition. Q5a was dropped from the suggested questions as all the vendors have this specialism attribute and so there is no differentiator value to this question.

In another embodiment, the Request Agent uses the existing relationships that the potential client has with other vendors to select or amend questions to the new vendors. The Agent retrieves relationships data objects with existing vendors and existing vendor data objects to determine common attributes, particularly for existing vendors of a type similar to the new vendor type that is being sought. For example, the Agent could classify a subset of the existing vendors as ‘manufacturers’ (being similar to the present search for a plastics manufacturer) and determine that they have common quality systems, locations, and size attribute values. The Agent then selects or amends questions for the new vendors that are relevant to these common attributes. Referring to FIG. 5, the Agent could have created Q2 based on locations the user appears to prefer for this vendor type, even without knowing where the potential client is based.

The Scoring Agent can also use the potential client's existing vendor relationship data to estimate question weights and estimate scores for new vendor responses, whereby higher weights are given to questions derived from more common attribute values and higher scores are given to new vendor attribute values closest to the existing vendor attribute values. These estimates speed up the request process by pre-populating the scoring system but may also be edited by the client-user. For example, a particular city may be common in the existing vendors' location attribute such that location responses are scored based on their proximity to this city.

In another embodiment, the Request Agent uses Natural Language Processing (NLP) such as Topic Modeling to determine popular topics of questions from previous questions asked towards the selected vendors or the type of selected vendors presently being sought. The Agent may employ Information Retrieval and Machine Learning techniques such as TFIDF, Chi-squared feature selection to determine keywords, industry acronyms and standards, and concepts that are commonly used to evaluate a vendor's industry/product/service. Preferably the Agent more highly weights questions that are more commonly asked and asked by clients that are similar to the potential client. This focuses the questions to aspects that are relevant and important to the potential client.

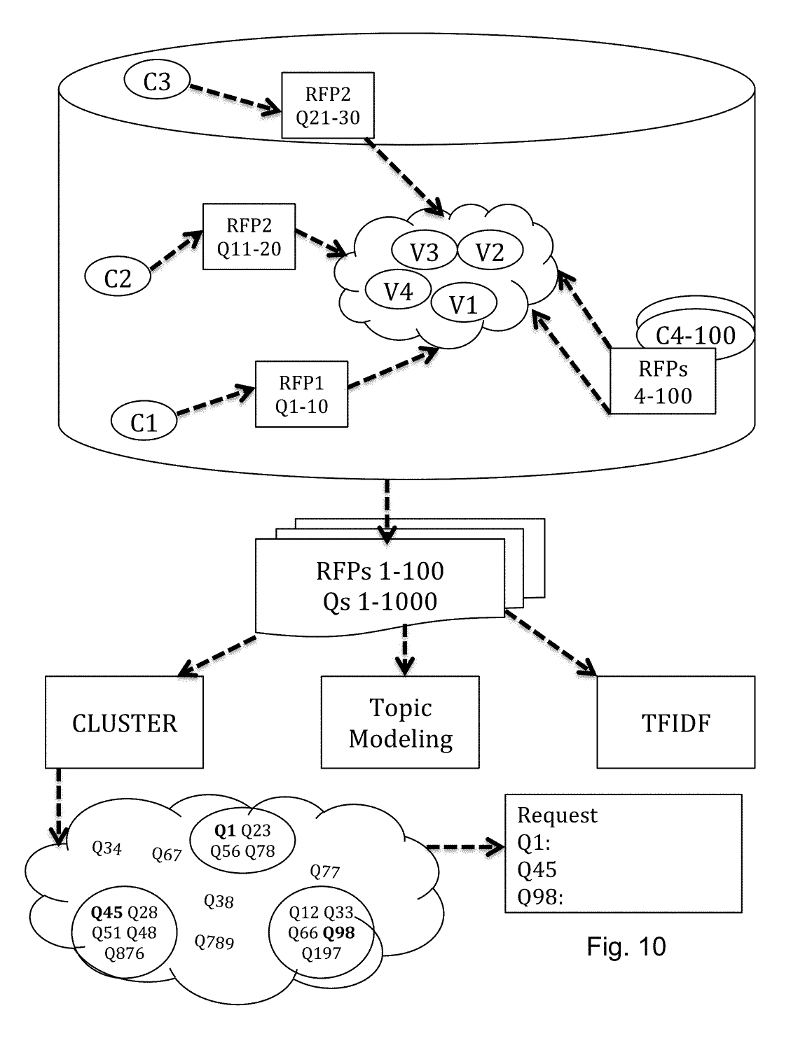

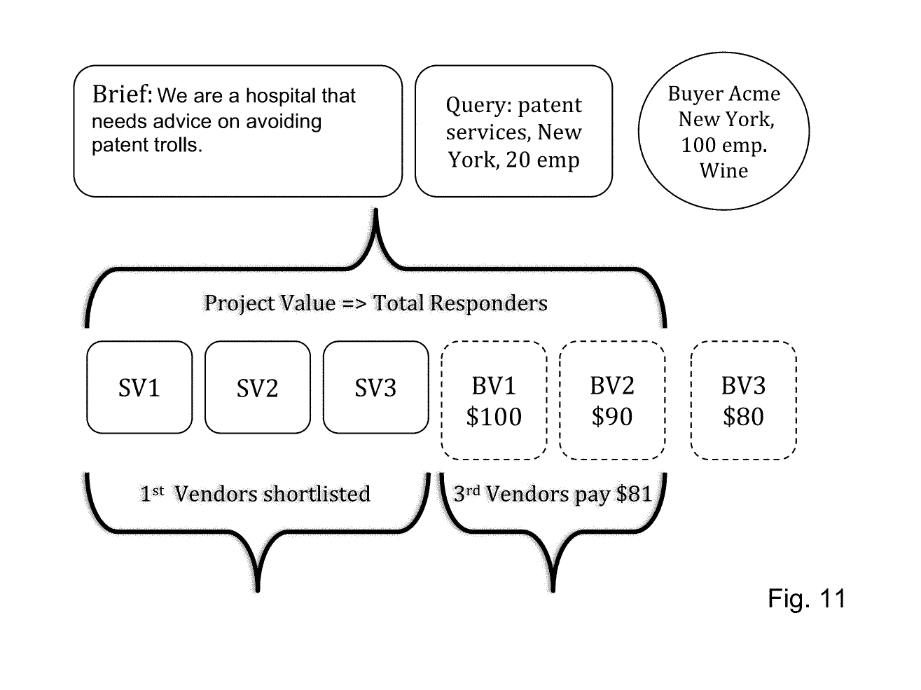

FIG. 10 illustrates a database comprising data objects of connected vendors, clients, and Requests. As shown, a plurality of vendors (V1-4) is grouped by a common category of industry or product. The system has recorded that clients (C1-100) have previously made Requests (RFP1-100) of the relevant category. Assuming each Request had ten questions, the system has 1000 questions from which a Topic Model, or Vector Space Model can be created. The Request Agent may create a plurality of Request questions derived from the most common topics or question clusters.

Thus even if sufficient data is not contained in the potential client's data object, the Agent can infer that similar organizations care about similar questions in evaluating a particular category of vendor/product/service. For example, in FIGS. 5 and 4, the system could have identified that quality systems were important to medical device companies and that two quality standards in particular were commonly queried by these companies. Possibly the quality standards were not recorded with the potential client data object and yet the Request Agent could suggest that such a question would be important.

The Agent may suggest an exemplary question from amongst the past questions or generate a question for each identified common topic using Natural Language Generation (NLG) and the identified keywords, acronyms, standards, etc.

The Request Agent compiles the selected and amended questions to create a request document to send electronically to vendors. The document may additionally include attachments or information detailing the products or services required.

### Vendor Response

Once the Request has been formulated it is sent to selected vendors or self-selected by vendors for responding. There may be many questions and each response may require many hours to formulate. There is thus an advantage in using a processor to pre-populate the responses for each vendor. A Response Agent determines the likely responses and suggests these to the vendor-user. For each question, the Agent may suggest one or more options and the vendor-user may edit a selected response. The Response Agent may be used in other steps of the present process, such as determining good questions and estimated vendor scores.

The Response Agent can retrieve data about the vendor and their relationships with existing clients from the database to determine the likely answers to these questions. For the questions of FIG. 5, the vendor data object may include data, such as the quality systems used or factory locations, to objectively provide fact-based responses about the vendor. Each relationship data object may include data about the provision of product/services and links to a client data object, which objectively provides responses about the vendor's clients, projects, and actual services. A distinction can be made here in the services/products offered by the vendor (vendor data) and the services/products actually supplied (relationship data).

Access to this fact-based data in the database makes for an efficient response process which provides verifiable values that can also be compared across vendors. For example, whilst a human answer could be intentionally misleading or vague, machine-generated responses may be created from values that have been verified and are directly comparable to other values. Similarly the vendor-user may respond that the vendor is capable of providing the relevant services, whereas the present system can determine from the relationship data whether or not and to what extent those services are actually provided to clients.

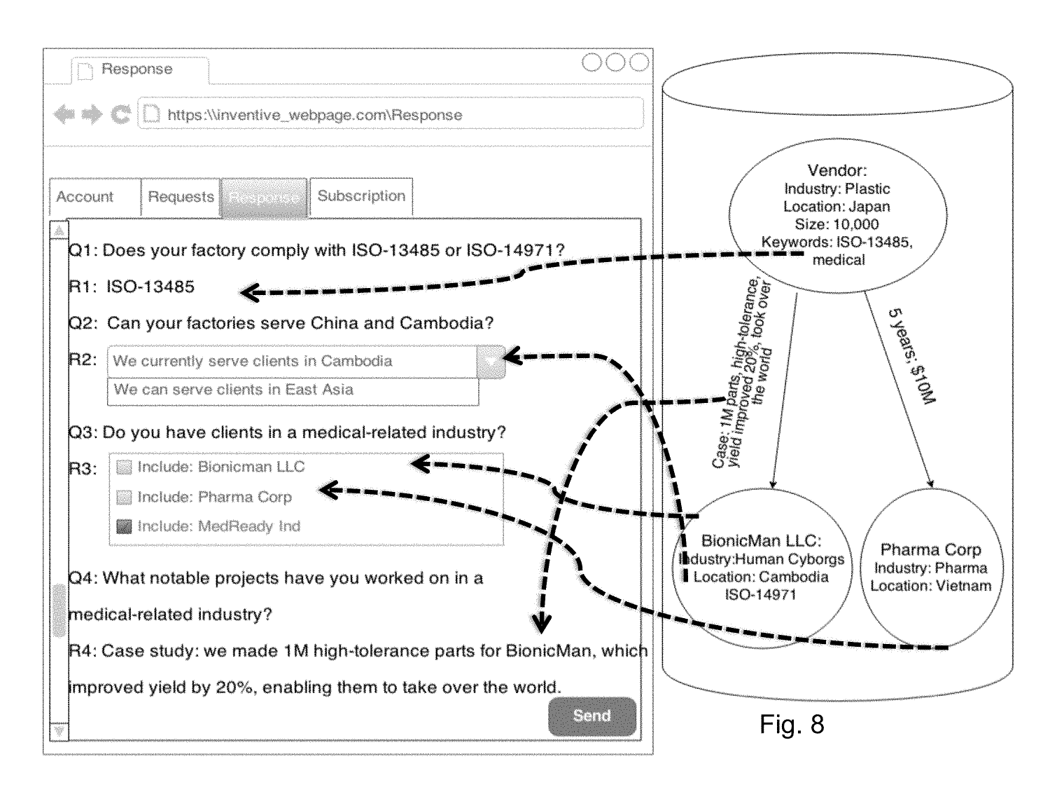

FIG. 8 shows a UI (left side) for responding to the Request, which is being auto-completed by the Response Agent using the database (right side). As shown the suggested responses are derived from the Vendor's, Client's and relationship data object. In this example, Question 2 is tagged as being a location question, to which the Response Agent retrieves values tagged with the location attribute type. Given the three location values (Japan, Cambodia, and Vietnam) and the range of permissible responses (Cambodia or China) the Agent generates natural language options for the vendor-user to choose. Question 3 is a client question and is auto-answered using client data objects. Question 4 is a case-study question is auto-answered using a case-study stored with a relationship data object.

A more detailed response can also be formed using past responses to similar questions. Preferably the Response Agent uses NLP or similar machine-learning techniques to classify questions and match the present question to similar past questions. The Response Agent then selects one or more past responses to the similar past questions and suggests this to the vendor-user.

Alternatively the Response Agent analyzes a plurality of Requests from a plurality of potential clients and identifies clusters of similar questions. The vendor-used is then prompted to provide a response for each of the clustered questions, which response is then used and re-used for the individual questions in the respective clusters.

Alternatively or additionally the Response Agent may retrieve case studies or influential project details from a relationship data object connected to the relevant client.

In addition to predicting or receiving vendor responses the present system may add unsolicited content to a response document. The content may include: case-studies, prepared sales material, unique selling points, client endorsements, infographics, or aggregated client attributes. This content may be prepared offline and stored with the vendor or relationship data object or created in real-time. The Response Agent may select content that is most relevant to the original search query, Request questions or to the potential client. A vendor data object may have a plurality of content items, wherein each is tagged to indicate the category of client or question that would be interested in it. The Response Agent may determine the industry of the potential client, the category of products or services being sought, and keywords defining the questions asked. The Agent then selects matching content items.

### Vendor Scoring

Another time-consuming task is scoring the responses of many vendors to the many questions. The scores may however be subject to user bias and inconsistency. The present system employs a Scoring Agent to automatically score the responses using data from the database.

This Agent may calculate a vendor score as the sum of weighted scores for each answer, whereby each question is assigned a weight and each expected response value is assigned a score. The Agent then performs the linear algebra using the response values provided by each vendor. The weights and scores of response values may be explicitly entered by the user but in certain embodiments, the Scoring Agent predicts and populates these weights and scores. Preferably the weights and scores are set during the step of creating the Request so as to remove bias and enable score predictions. Embodiments for setting weights based on question differentiation are discussed above. Other embodiments are discussed below.

In one embodiment, the Agent determines the question weights and scores for the Request from attributes of the potential client or their peers. The Agent retrieves from the database relevant attribute values of the potential client, of organizations similar to the potential client, or of relationships or these similar organizations with vendors similar to the presently selected vendors. The attribute values are aggregated to determine popular values and/or trends in time. The score and weights may be increased when derived from highly similar organizations or the potential client itself.

For example, the Agent may aggregate attributes of peer organizations and the potential client to determine that a certain location is very common and that the organizations typically form relations with vendors in nearby locations. The Agent determines which questions are location-based and weights these highly based on the consistency of the location attribute and scores location values used in the response inversely with the distance from that common location.

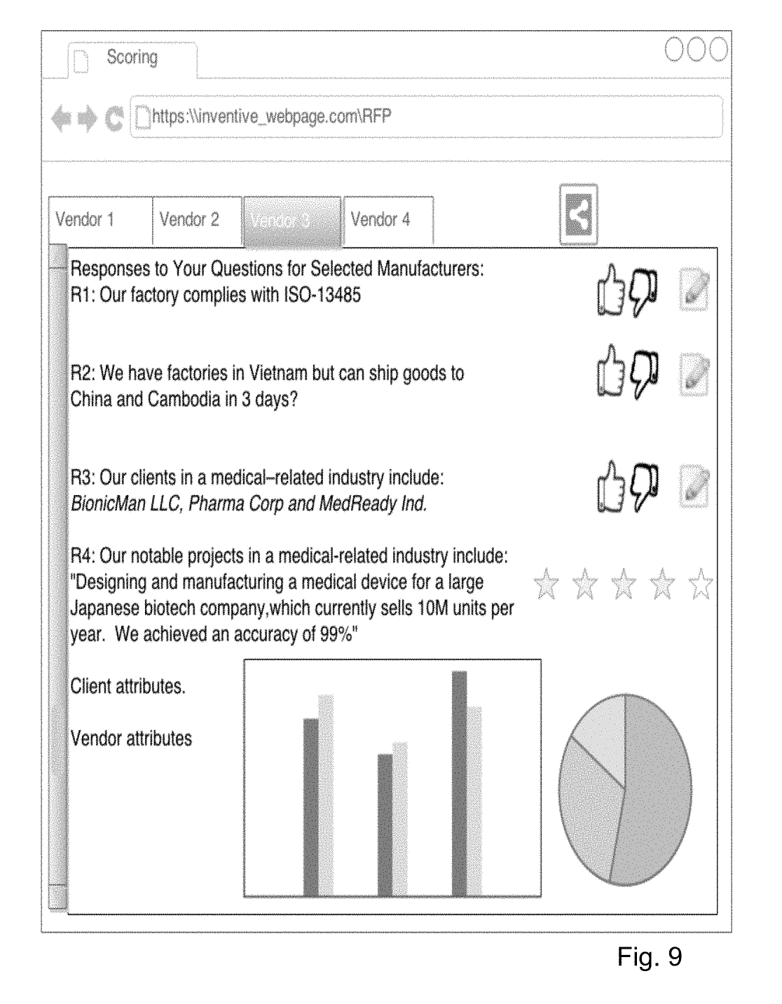

Returning to Q1 of FIG. 5, the Agent determines which of the attribute types or other data are relevant to the question's topic, ‘quality systems’. The Agent may determine that a high proportion of similar organizations or their relationships have values recorded that are relevant to quality systems and thus the Agent weights this question highly. This may require classifying their data to determine which attribute values, tags or keywords are related to the question's topic. The attribute type may have a label that matches the question's label. The Agent may also determine that one of the values for quality systems is more common than others and so score response values that match this common value more highly. For example, in FIG. 9, the response value, “ISO-14385,” may repeatedly match the values in the potential client's relationships with other vendors in the manufacturing category and thus scores highly.

In one embodiment, the Scoring Agent uses machine-learning to discover what response values are better than others. In FIG. 9, the user-interface for reviewing the vendor responses includes interactive elements beside each response for the client-user to enter comments, rate or indicate approval/disapproval. In preference to binary scoring, the UI may provide a scale, such as 1-10, for the user to quantify the response score. The client-user may also provide comments on responses, which are saved in memory or shared with other employees working for the potential client. In this case, the Scoring Agent uses sentiment analysis on the comment text to determine whether the related response is viewed positively or not. Thus the client-user may review the responses in their own way, while the Agent estimates their scoring preferences in the background.

In another embodiment, the Scoring Agent sends the vendor responses to a plurality of users associated with the potential client or the user who originated the Request may instruct that other users have access to the vendor responses to score them. Thus the final vendor scores may be determined collaboratively, wherein each client-user can like, score or comment on responses.

The Agent learns what response values are given what scores. This can be used to score other vendors and also in scoring subsequent Requests without the need for the client-user to re-enter a score each time. Advantageously this provides consistency across similar responses and saves the client-user time. In addition to ensuring consistency for identical response values, the Agent can ensure internal consistency with response values on a continuous scale. For example, if item price is scored inversely with the response value, then the Agent can ensure that the client-user must score a vendor's low priced item higher than a competitor's high priced item.

The Agent may then tally the number of positives/negatives or sum the quantified scores to evaluate each vendor. The calculated scores may be displayed on a website in detail or used to rank the vendors overall.

The Agent may score responses at least party by verifying the response value. The Agent may determine whether a value used in a response can be matched to the attribute values of the vendor or of the vendor's relationship with clients. Preferably the Agent determines whether or not and the degree to which an attribute has been verified. Methods of verifying data are discussed in U.S. 62/082,088, entitled “Business Relationship Accessing,” incorporated herein in its entirety. That application discusses how data may be verified by scraping web data or confirming with an organization connected to the vendor.

In one embodiment, the scoring agent may initialize or set the question weights depending on filter values selected by the user via the UI. For example, if the user has selected a particular employee count for the vendor size filter, then size-related questions are highly weighted compared to other questions and a vendor's score will depend on the closeness of the vendor size compared to the user's filter selection. The scoring agent may calculate a vector distance between a vendor's attributes and the user's attribute filter selections.

The Scoring Agent may also be used to estimate scores of predicted responses, and may be called by the Request Agent and Request Evaluation Agent.

### Evaluating Requests

From the client's perspective, an outcome of the process will be the scoring/ranking of selected vendors. However the selected vendors may not want to respond to every Request posted by potential clients because of the effort involved. Using the business database the present system can evaluate the monetary or non-monetary value of each Request to a particular vendor. Thus when a vendor-user is notified of one or perhaps many pending Requests, they are also notified of how attractive the Request is to that vendor and/or how likely they are to succeed.

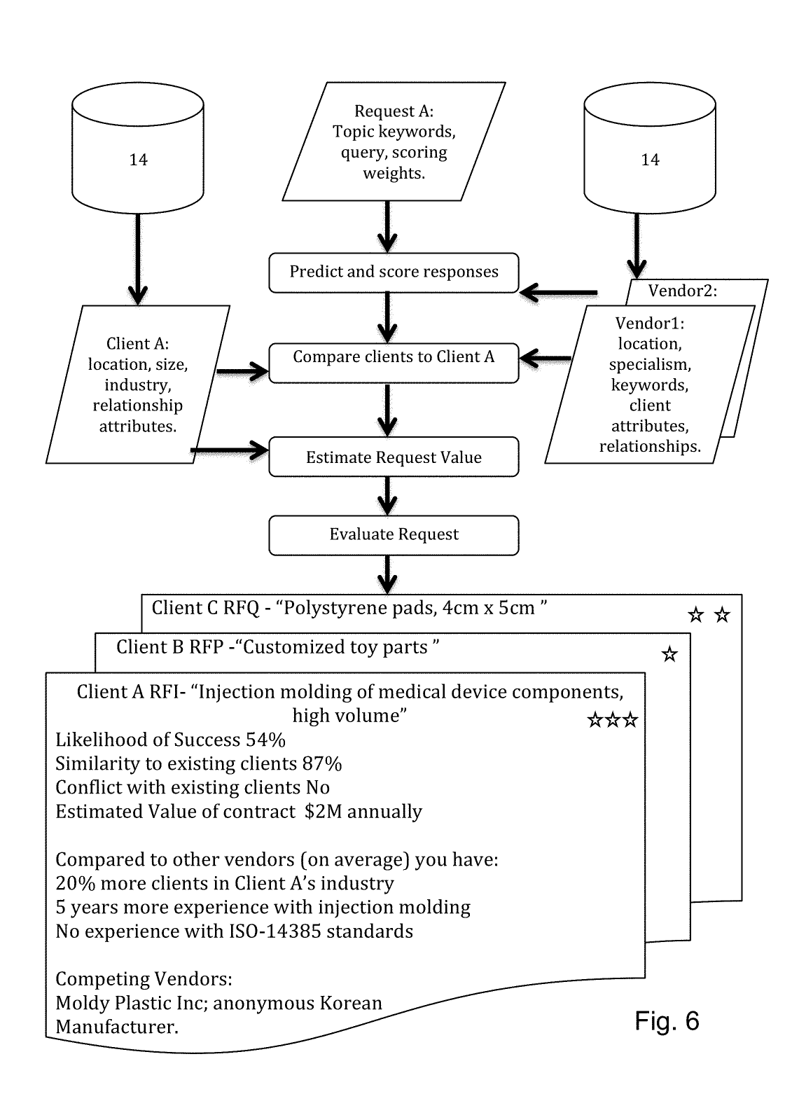

FIG. 6 is an illustration comprising a flowchart for evaluating Requests, the data used, and resulting content for displaying to a vendor. The flowchart is an example process used by a Request Evaluation Agent, which itself may call other agents to estimate vendor responses and scores. The Request Evaluation Agent uses the Response Agent to predict responses that the vendor would give to questions in a particular Request using a Vendor's data such as their attributes, their client's attributes and their relationship attributes. The Scoring Agent uses the predicted responses to estimate the score that each vendor might receive if the vendor chose to response. A particular vendor's score can be evaluated in absolute terms or relative to the other vendors to determine their likelihood of success in receiving business from the potential client. An example is shown in the documents of FIG. 6, whereby the vendor is estimated to have a 54% chance of success with Client A.

The Request Evaluation Agent uses the similarity scores calculated by the Similarity Agent (discussed above) to calculate a similarity statistic between the potential client and clients of each vendor, such as average similarity score or the number of clients that are similar/peers to the potential client. This calculation provides the vendor with a measure of whether the potential client would be a good fit and a measure of how the vendor might use existing clients to win the business of the potential client. An example is shown in the documents of FIG. 6, whereby the potential client is 87% similar to the vendor's clients.

A Conflict Agent determines whether the potential client would create a conflict of interest with a vendor's existing clients. The database 14 may store, in a data object for an organization, a set of other organizations that are close competitors or otherwise in conflict with each other, such that the Conflict Agent can detect when a vendor would have a conflict working with both clients. An example is shown in the documents of FIG. 6.

The Request Evaluation Agent may use attributes from the data object of the potential client or their relationships with vendors in a model to estimate a financial worth of the Request, preferably using at least two attribute types for better accuracy. For example, the Agent may use the size, revenue, industry and lifespan of the potential client to determine how much money they are likely or capable of spending. Similarly the duration and spending of their existing relationships with vendors in a category similar to the present query can be used to model the client's typical spending. The model may estimate annual spending, one-off spending, quantity of products needed or duration of the service needed. An example is shown in the documents of FIG. 6, whereby the Request is estimated to be worth $2 M annually.

The Request Evaluation Agent may compare attribute and relationship data across the selected vendors to determine relevant differences. The Agent may first determine attribute types that are relevant to the potential client, their query or their Request. The Agent then retrieves attribute values for each selected vendor for these relevant attribute types. The Agent then compares the attribute values to determine (a) a ranking of the vendors for each attribute type or (b) the difference in the attribute values between a particular vendor and the other vendors. The difference may be expressed as an absolute or percent difference between the value of a particular selected vendor and the average value of the remaining selected vendors. The rank or difference in the relevant attribute types for a particular vendor is then communicated to that vendor. Examples are shown in the documents of FIG. 6, whereby the vendor is determined to have 5 years more experience than other vendors.

The Request Evaluation Agent may store a direction of advancement for each attribute type that is used to determine whether a change in attribute values corresponds to a positive or negative support for a particular vendor. The Request Evaluation Agent predicts the likelihood of success for a Request based on the number and degree of positive or negative differences for a vendor.

The Response agent may use the computed differences that provide positive support in order to suggest responses to a vendor. The Response Agent may use tags of questions or machine learning (such as NLP) to determine which questions in the Request are relevant to attribute types for which a vendor has positive support. For example, for questions having keywords “experience” and “injection molding” the Response Agent would determine the positive support for a vendor and calculate the difference to suggest that the vendor highlight their greater experience in their response, such as ‘You have more experience with injection molding than the other manufacturers'’ (See FIG. 6).

The Request Evaluation Agent prepares evaluation metrics for each vendors using at least one of: the client similarity statistics, the estimated vendor's response score, conflict check, estimated worth of the Request, and identified vendor differences. Preferably a plurality of evaluation metrics are output as web content using the Serialization Agent. The skilled person will appreciate that various evaluation metrics may be calculated using a variety of algorithms. One example metric may be the expected monetary worth of the Request multiplied by the likelihood of success.

Given that a particular vendor may want to choose from amongst several Requests, the Request Evaluation Agent may calculate an evaluation metric for that vendor's received Requests relative to the other Requests. The Request Evaluation Agent may rank the Requests of a particular vendor.

### Access Rights

Access to different levels and steps of the Request process may be limited by the system for vendors depending on their access rights. An Access Agent maintains access rights for each organization in memory (possibly within the data objects in the organization database). Preferably users associated with a particular vendor inherit the access rights of that vendor. The vendor's access rights may be increased or decreased depending factors such as: whether the vendor has created an account with the system, the period of the vendor's account; the amount of data that a vendor has contributed to the database; or a fee paid.

The Access Agent uses the access rights data to determine whether features are enabled such as: permitting a vendor-user to receive Requests; permitting a vendor-user to view only some of the questions of the Request or view all questions in the Request; permitting a vendor-user to respond to the Request; computer generation of content from the database of business relationships to their response; computer generation and addition of infographics to a response; computer generation of pre-populated response suggestions; permitting a vendor-user to view data about the potential client making the Request; or computed evaluation of the Request prior to the user choosing to respond.

For example, the Access Agent may permit every vendor to receive a notification that they have been selected to provide business information to a potential client. However only vendors with an account may view the entire set of questions. The Agent evaluates the relevance of the Request and pre-populates responses for the vendors with the highest access rights. Vendors without an account could receive notification by email sent by the present system, whereas vendors with an account could log-on to view their Request notifications, such as a queue of pending and posted Requests.

The levels of access rights may be arranged as a sequence from lower to higher rights, whereby progressively higher rights have access to features of the preceding rights plus at least one more feature. Alternatively the access rights of a vendor may enable a specific feature to vendor-users without requiring access to another feature. The access rights may be derived from an ongoing plan subscribed to by the vendor. For example, there may be a basic plan that is free to all vendors that create an account, a mid-level plan for vendors that pay a moderate amount for moderate access rights and premium plans for vendors willing to pay to access all parts of the system.

The access rights for a vendor may depend on the spending of credits available in the vendor's account. A vendor may acquire credits over time, or through contributing data to the database, or making a payment. The vendor-user may then chose to expend a number of credits to access a feature of the system.

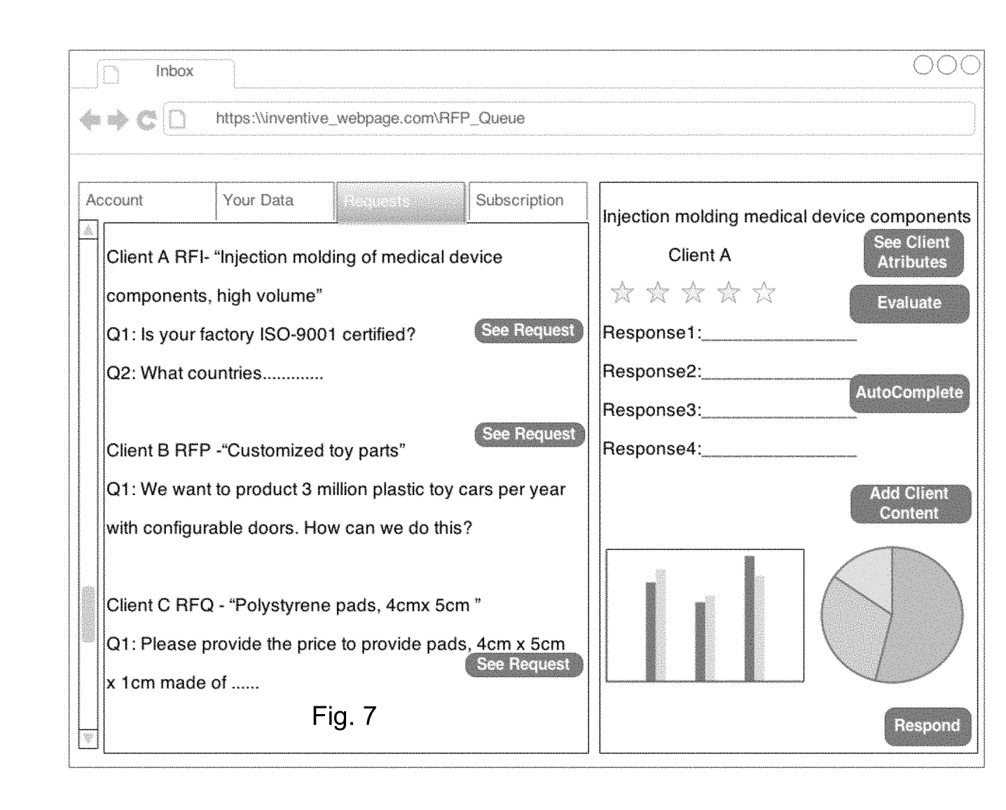

The system provides a user-interface to a vendor-user comprising access-dependent features for viewing and responding to the Request. The Access Agent identifies the vendor and determines from the database their access rights or credits. The Access Agent then enables or disables the features depending on the vendor's access rights. The interface may provide enable/disable buttons for the user to click on to run the software feature. In the example of FIG. 7, the user-interface is a webpage displaying portions of several Requests. Each Request is accompanied by a button for viewing more of the Request. The button is enabled for vendors having viewing rights. Alternatively the system subtracts from a vendor's credit if the user clicks on the view button. Similarly the webpage provides a button for responding to a given Request, a button to view the potential client's attributes, a button for evaluating the Request, a button for auto-completing the responses, and a button for adding infographic content about the vendor or their clients.

The Access Agent may also use affect the timing of sending or permitting viewing of a Request. Thus while vendors with priority access will be sent the Request at a first time (e.g. substantially immediately), other vendors without such access rights will receive the Request at a second time, after the first time. The delay between first and second times is preferably at least one day. To do this the Access Agent may set a delay flag or create a scheduling table for selected vendors, which is stored with the Request object. The Communication Agent may use this data in the overall scheduling of sending of a plurality of Requests to vendors.

### Anonymity

Although the system records the identity of the potential client, their peers, the selected vendors and their clients, in certain embodiments the system does not display all of these identities to all users. Determining whether an organization is identified or anonymized in a display may be based on: (a) an anonymity status of an organization in a relationship in the database; (b) access rights of one of the organizations; or (c) system rules designed to ensure user's actions are unbiased. In the graph of FIG. 2, organizations are recoded in a relationship edge as visible or anonymous.

In one embodiment, the system displays the Request to the vendors without revealing the potential client's identity. The system may display attributes of the potential client to assist the vendor in deciding whether and how to respond to the Request.

In another embodiment, the system displays the vendors' responses to the client without revealing the vendor's identity. The client-user is thus able to score the responses without being biased by the identity of the vendors.

Details of how to operate a database with anonymous organizations are discussed in U.S. 62/082,088. As discussed therein, a recommendation of a vendor to a user does not include identity data of their clients. In the present context where a vendor is attempting to provide an enticing response to a potential client, the system provides an option, via the UI, for a vendor-user to remove the anonymity of a particular client for the purpose of displaying the client's identity to the user making the Request.

### Two Sided Networks

Networks for two-sided market are an efficient way for otherwise unrelated buyers and vendor to find each other. One example is that of a buyer who has a project that requires services of a vendor to be found. Whilst both sides receive some value from the network's ability to find the other side, there is often a mismatch in the perceived value of the project and uncertainty in the information provided from the other side.

Providing perfect information to all sides may be impossible and may undermine the network's function if user can use the complete information to circumvent the platform. When buyers stimulate the demand-side of the market, there is a challenge to balance between getting enough vendors interested to create competitive alternatives versus getting too many vendors that inundate the buyer.

Similarly, there is a “problem-of-the-commons” for vendors, whereby every vendor is motivated to make a proposal to the buyer and thus diminishing each vendor's own odds of winning (and also overwhelming the buyer). This is relevant because there are significant other costs (such as time) associated with making the proposal that will cause some good vendors or buyers to dropout.

Some networks aim to connect buyers and vendors, whereby vendors pay a fixed per-project fee or monthly subscription. However there still remains the problem connecting the two sides given that they each have different motivations, project valuations, and ideal matching parameters. The two sides thus behave differently without a mechanism to ensure fair play. A marketplace approach to the project suffers from taking too much control and choice away from the buyer by allowing the vendors to self-select. Whereas the fixed subscription model allows vendor to approach all buyers without any self-regulation, the fixed per-project fee model will not accurately or dynamically appreciate the value of the project.

The inventors have appreciated deficiencies in the current state of two-sided networks and the need for a computer intermediary. A particular scenario is envisaged wherein a buyer has in mind a project that requires the services of a vendor. The project is unique such that information is imperfect for both sides but especially the vendor. The project is concluded outside of the platform and requires further negotiation and clarification such that providing a final quote at early stages of the process is meaningless. The work may go on indefinitely or change scope such the project is not a fixed entity that can be quoted. These problems are complicated because there may be thousands of vendors selecting from amongst thousands of unique, changing projects with varying deadlines.

The present system provides a combination of search engine and auction engine, which enables buyers to find a first set of vendors, shortlist a second set of vendors, and enables vendors to bid to be part of a third set of vendors. The second and third sets of vendors are given access rights to contact the buyer, typically via the present system.

The search engine enables the buyer to search and discover the types of vendors available and make vendor choices that reflect their own priorities and perceived fit.

The auction engine is a way to elicit the maximum of all perceived values that bidders place on a given auction lot. However in the present scenario, the perceived value of the project will depend on the clarification and certainty of the project. There may also be uncertainty about the buyer and his seriousness. Therefore the system also provides as much information about the project and buyer as possible, without revealing the buyer's identity data. Identity data may include data other than the name, such as data that could be used to evince the identity.

The system also reveals the rules and conditions of the auction, prior to the auction, including the number of vendor spots to be won and/or number of shortlisted vendors. This number will inform potential bidders about their chance of working on the project if they do win one of the bid spots.

### Auction Engine

The auction engine provides an interface for receiving bids from vendors and determines winning vendors based on predetermined set of auction rules. The rules may provide for a Vickrey auction or Vickrey-Clarke-Groves auction where more than one bid spot is available. Therefore every bidder makes their best bid but the highest N bidders pay whatever bid would have been sufficient to beat the highest losing bidder (N+1).

The system may provide multiple techniques for including or excluding vendors from viewing or bidding. Vendors may opt-in to receive notifications about projects matching pre-set criteria which is set via a UI. Alternatively the search engine identifies and scores vendors that satisfy the search query or are similar to the shortlisted vendors and sends a notification about a new project available to bid on. The system may enforce certain qualification requirements in order for vendors to view or bid, such as satisfying the search query greater than a threshold degree or having an account with bidding rights with the present system.

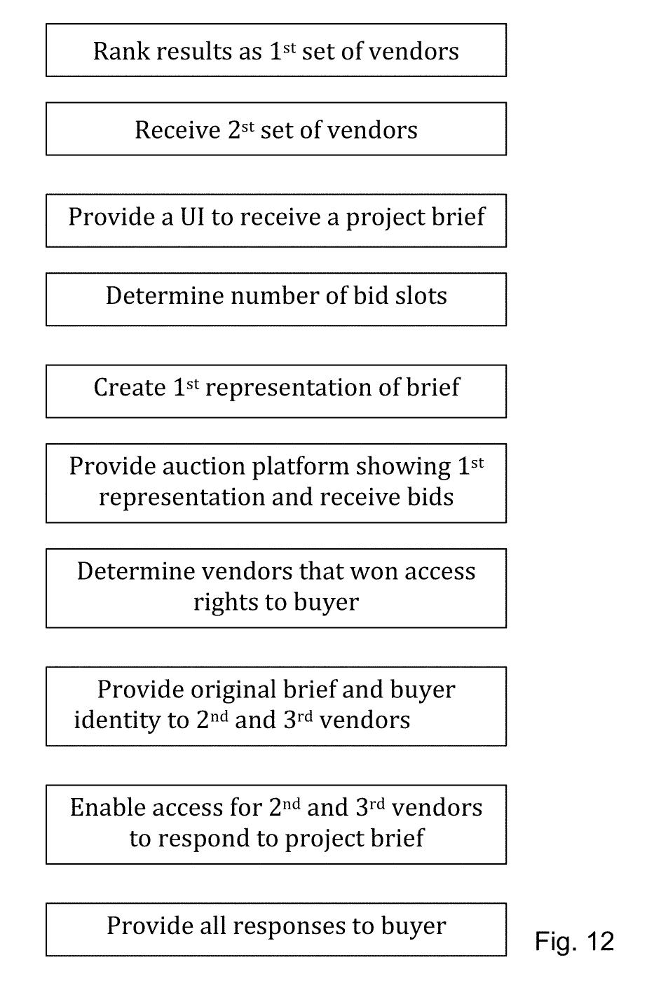

There may be a fixed number of bid slots available to be won in the auction, such as two slots. In certain embodiments (see FIGS. 11 and 12), the auction engine estimates or receives an indication of the project value to determine the number of bid slots. An algorithm is used to determine a total number of responders (second and third sets of vendors), which total number increases with the project value. Preferably the total number increases logarithmically with project value. From the total number is subtracted the number of second vendors selected by the buyer-user to set the number of bid slots. The algorithm may be:

N Bid slots=maximum(1,Round(LN(project/80))−num_shortlist)

A modification of this algorithm may account for an estimated or actual non-response rate of shortlisted vendors to reduce Num_shortlist which correspondingly increases the number of bid slots N.

In certain embodiment, the system separates the brief into at least two parts: a first part that includes sufficient data for a vendor to self-select and make an informed bid; and a second part that includes the remaining data needed for the responding vendors to provide a meaningful response.

Separation into parts may be achieved by providing at least two fields to be completed by the buyer-user in the User Interface. For example, there may be a field for a title, a field for a description of the buyer's situation/background to the project, a field for a goal of the project, and a field for specific requirements of the desired vendor, and questions to be answered by all responding vendors. Certain of these fields form the first part provided to bidders. Certain of these fields form the second part are provided to vendors with access rights for responding. The module selects text from the pre-determined set of fields to create the respective first and second parts. For example the first part may comprise the title, situation, and requirements about the vendor. The second part may comprise the remaining fields.

The first or second parts may comprise other data such as attributes of the search query or attributes of the buyers, whereby less attributes or more generalized attribute values are comprised in the first part and more attributes or original attribute values are comprised in the second part.

The project may alternatively be displayed to vendors with two different representations: the original and a generalization. This may be achieved by the module computing attribute values that are generalizations of one or more of the attributes of the buyer or of the search query. For each of one or more of the attributes, the module determines an attribute value that is broader or more general than the original attribute value.

For example a query may be for a firm of a specific size (20 employees), in a specific location (Alexandria) from a buyer organization of a specific industry (wine). The module would compute a broader numerical range for size (10-50 employees), a region encompassing the location (Virginia), and a higher-level industry in the taxonomy (food & beverage).

The generalized attribute values may be provided to bidders to enable them to self-select based on relevance and to estimate the value of the project. The original, specific attribute values are provided only to responders.

Certain embodiments may take extra steps to preserve the anonymity of the buyer from the bidders. This may be achieved by carefully selecting or generalizing attributes of buyers as discussed in U.S. Ser. No. 14/946,082, incorporated herein in its entirety. U.S. Ser. No. 14/946,082 also teaches methods for verifying the identity of an organization, which may be used in the present bidding platform to verify the buyers identity to ensure that the projects are real and to verify the bidders identity to ensure that the vendors are qualified to access this system and provide a meaningful response.

Advantages of certain embodiments may include:

vendors that are very relevant to the project can self-select but are self-restrained by the limits that they set on their own bids;
the buyers can exercise their choices in vendors;
the buyer and vendor are not legally bound to work together yet;
the buyer receives a manageable number of responses.
the vendors have a known and reasonable chance of winning the project; and
the value of the project is dynamically optimized.

### Social Networking

As taught in U.S. 62/101,952, incorporated herein in its entirety, social networks may be used to recommend organizations to users by determining people that the user has a social connection with a potential vendor or their client. Social contacts may be found from reciprocated links in social networking sites such as LinkedIn™, Viadeo™, Facebook™, and Google+™ as well as unilateral connections such as ‘Following’ on Twitter™ and associations with affinity groups made via social media. Through social websites, it is also possible for a person to Follow or link to a company, which may establish that the user is interested in that company and would be influenced by organizations with whom they have a business relationship.

A user preferably logs into a website of the present system, using their social media credentials, to access the recommendation engine and establishes their association with an organization. For example the user may log in to the website using a LinkedIn™ account to grant the website permission to access data about their jobs and social contacts.

During the request process, the present system may identify, from a social network, employee(s) of the potential client, employees of the vendor or their clients, and all social inter-connections. The system may display these social connections in the Request to the selected vendors. The vendor may use this information to better prepare their responses or decide to enlist the help of their employees who know the potential client's employees. The UI for the response may provide a particular vendor with capability to solicit endorsements from employees of their clients that have a social network connection with the potential client's employees.

In another embodiment, the system may display, in the response document, employees of the vendor or their clients that have a social network connection with the potential client's employees. The potential client may then ask their employees that are connected to vendor/client employees to vet the response or contact the vendor's or their clients' employees for more personal information.

In a variant of the above-described request for business information, a Request may be made to vendors that are individuals, instead of organizations with many employees. The individual may be a sole proprietor, professional, tradesperson, or consultant.

The individual's data may be maintained on and retrieved from a social network or database of business relationships. The individual may be a user with an account on a website, such as LinkedIn™, Facebook™, Angieslist™, or Twitter™.

A potential client-user (as an individual or employee of an organization) may log onto the social network and search for an individual as a service provider. A search engine may identify all users of the social network that have a skill, qualification, experience, or keyword in their profile, matching the search query. The search engine may also identify other users that have a social connection with the potential client and any of the identified service providers.

The potential client-user selects a plurality of the identified service providers and initiates a Request for information through the present system. The Request Agent creates a Request for information for a plurality of selected individuals using the methods discussed herein. The Request Agent may also create and/or score responses for the selected individuals using the methods discussed herein.

### Displaying Data

The system receives and sends requests and responses to users via a user interface on the user's computing device. The system may prepare web content for the request, response and scoring. A serialization agent serializes the web content in a format readable by the user's web browser and communicates said web content, over a network, to a client's or vendor's computing device.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” and “I” (the slash mark) between alternatives is to be understood in the inclusive sense, whereby either alternative and both alternatives are contemplated or claimed.

Reference in the above description to databases are not intended to be limiting to a memory device, particular structure or number of databases. The databases comprising a social network, social media, template questions or business relationships may be implemented as a single database, separate databases, or a plurality of databases distributed across a network. The databases may be referenced separated above for clarity, referring to the type of data contained therein, even though it may be part of another database. One or more of the databases and agents may be managed by a third party in which case the overall system and methods or manipulating data are intended to include these third party databases and agents.

For the sake of convenience, the example embodiments above are described as various interconnected functional agents. This is not necessary, however, and there may be cases where these functional agents are equivalently aggregated into a single logic device, program or operation with unclear boundaries. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A computer-implemented method of requesting information about a plurality of vendors or their products, the method comprising:
a server recommending a set of questions to a first user associated with a potential client;
the server communicating the request questions to a plurality of second users associated with the plurality of vendors;
the server recommending a personalized set of responses to said request questions to the second users;
the server providing a user-interface to enable the second users to approve or edit the recommended set of responses to form final responses; and
the server communicating said final responses to the first user,
wherein the recommended set of questions are selected based on attributes of the potential client and recommended set of responses are selected based on attributes of the respective vendor, all of said attributes being stored on a database accessed by the server.

2. The method of claim 1, further comprising providing a search engine for selecting the plurality of vendors and selecting recommended set of questions and recommended set of responses based on a relevance score to a search query entered by the first user.

3. The method of claim 1, further comprising retrieving attributes of the potential client from the database and communicating these to each second user.

4. The method of claim 1, wherein the server recommends the set of questions by selecting from a set of template questions based on the potential client's industry data and personalizing the questions using the potential client's attributes.

5. The method of claim 1, wherein the server recommends the set of questions by selecting from a set of template questions based on the potential client's industry data and personalizing the questions using the potential client's relationships with other vendors.

6. The method of claim 1, wherein the server recommends the set of questions by selecting from a set of questions, stored in the database, previously used by organizations that have attribute data similar to the potential client's attribute data.

7. The method of claim 1, further comprising the server retrieving, from the database, case studies associated with each of the plurality of vendors and communicating the case studies with the responses of the respective vendors.

8. A computer-implemented method comprising:
a server receiving a request to contact a plurality of vendors from a first user associated with a potential client, the vendors selected via a website accessing a database of organizations;
a server retrieving, from the database, data about each of the plurality of vendors or about their relationships with their clients;
the server determining data types that are relevant to the potential client in relation to selecting vendors; and
for each vendor, the server, determining a set of differences in the data between that vendor and the other vendors which are relevant to the potential client and communicating the set of differences to a second user associated with that vendor.

9. The method of claim 8, wherein the data types that are relevant to the potential client are determined from at least one of: (a) search criteria selected by the first user for selecting the vendors via the website, (b) questions selected by the first user as part of the request to contact the vendors; or (c) attribute data about the potential client.

10. The method of claim 8, further comprising the server suggesting responses for each vendor based on differences, in the set of differences, that represent positive support for that vendor compared to the other vendors.

11. The method of claim 8, further comprising calculating statistics about the differences in the data and communicating the statistics to the second users.

12. The method of claim 8, further comprising, for each vendor, calculating a score of the request based on said differences and communicating the score compared to a score of another request sent to that vendor from another potential client.

13. The method of claim 8, further comprising the server receiving an indication from second users whether they wish to respond to the request to contact.
